(19) United States
(12) Patent Application Publication
(10) Pub. No.: US 2012/0124160 A1
(43) Pub. Date: May 17, 2012

(54) METHOD FOR TRANSMITTING/RECEIVING CUSTOMIZED CONTENT AND TERMINAL THEREOF

(75) Inventor: Min-Jung Shon, Gyeonggi-Do (KR)

(73) Assignee: LG Electronics Inc., Seoul (KR)

(21) Appl. No.: 12/673,328

(22) PCT Filed: Aug. 6, 2008
(86) PCT No.: PCT/KR2008/004036

§ 371 Date: Jun. 17, 2010

Related U.S. Application Data
(60) Provisional application No. 60/935,546, filed on Aug. 17, 2007.

(30) Foreign Application Priority Data
Apr. 22, 2008 (KR) 1020080037287

(51) Int. Cl. G06F 15/16

(52) U.S. Cl. 709/217

(57) ABSTRACT

Disclosed is a method for receiving a customized content in a terminal, the method comprising, transmitting a service subscription request message to a server; receiving user preference and one or more content packages from the server, wherein the user preference includes elements indicating one or more pre-defined profiles and a pre-defied condition, and each of the content packages includes an element indicating an identifier of a profile related to itself; and operating a specific content package according to corresponding profile when the pre-defined condition in the user preference is satisfied.

### TECHNICAL FIELD

The present invention relates to a method for transmitting/receiving a content, and more particularly, to a method for transmitting/receiving a customized content.

### BACKGROUND ART

Currently, in order for a terminal to download contents, the terminal accesses a server providing the contents and then selects a content which can be operated in the terminal among the contents provided by the server, thereby downloading the corresponding content.

In the related art, a content provision service was unidirectional in one time. That is, in the related art, the content provision service was implemented as the unidirectional service characterized in that a content provided in the server is selected and then simply downloaded, and as the one-time service characterized in that the content is automatically updated according to user preference.

Since the content provision service is unidirectional in one time, a buying desire of users on contents decreased. Accordingly, service providers were difficult to stably make profits.

### DISCLOSURE OF THE INVENTION

### Technical Problem

Therefore, it is an object of the present invention to download a content according to user preference and automatically update the content.

### Technical Solution

To achieve the object, in accordance with the present invention, there is provided a method for receiving a customized content in a terminal, the method comprising, transmitting a service subscription request message to a server; receiving user preference and one or more content packages from the server, wherein the user preference comprises elements indicating one or more profiles pre-defined by a user and a pre-defined condition, and each of the content packages comprises an element indicating an Identifier of a profile related to itself; and operating a specific content package according to a corresponding profile when the pre-defined condition in the user preference is satisfied.

To achieve the object, there is provided a terminal comprising a first client receiving from a server one or more content packages and user preference comprising elements indicating one or more profiles pre-defined by a user and a pre-defined condition, and then operating a specific content package according to a corresponding profile when the pre-defined condition in the received user preference is satisfied, wherein the first client comprises a package manager managing the packages; and a second client managing the received user preference and the content package in a device management tree format.

### BRIEF DESCRIPTION OF THE DRAWINGS

FIG. 1 is a block diagram showing each configuration of a terminal and a server in accordance with the present invention;

FIG. 2 is a block diagram showing each configuration of content packages and user preference in accordance with the present invention;

FIG. 3 is a flow chart showing a method for downloading and updating a content in accordance with the present invention;

FIG. 4 is a flow chart specifically showing a method for downloading and updating a content in accordance with the present invention;

### MODES FOR CARRYING OUT THE PREFERRED EMBODIMENTS

The present invention is applied to a wire/wireless communication system using customized contents. However, the present invention is not limited thereto and may be applied to every communication method and device to which technical sprits of the present invention can be applied.

A terminal in accordance with the present invention refers to all devices which can use customized contents. That is, the terminal in accordance with the present invention broadly includes mobile communication terminals (e.g., UE (User Equipment), cellular phone, portable phone, DMB phone, game phone, camera phone, smart phone, etc.), notebooks, desktop computers, PDAs (Personal Digital Assistant), white household appliances, etc which can use the customized contents.

Hereafter, a preferred embodiment of the present invention will be described in detail with reference to accompanying drawings.

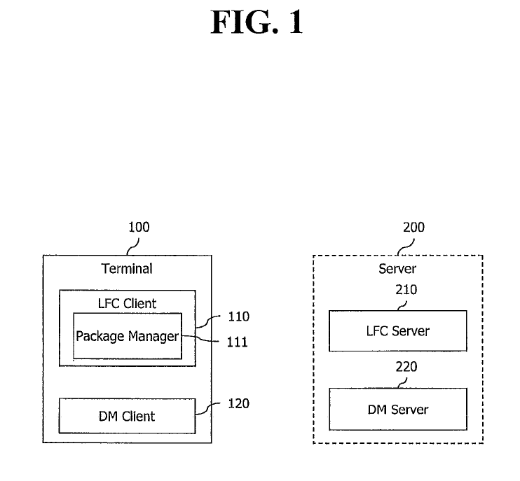

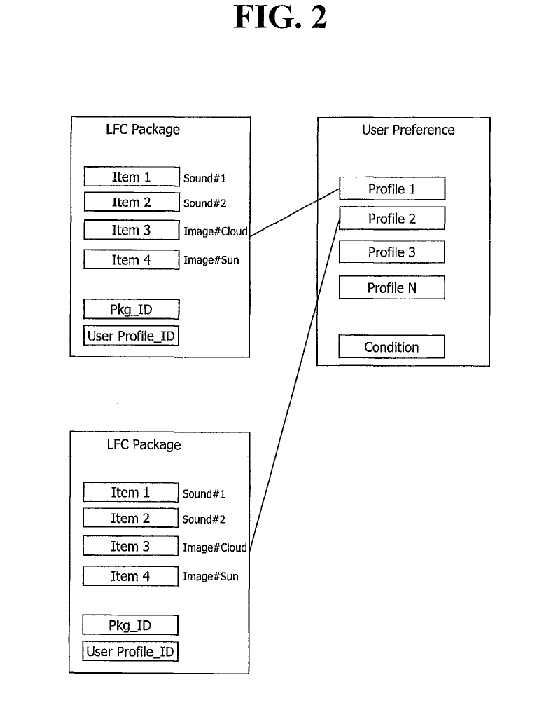

FIG. 1 is a block diagram showing each configuration of a terminal and a server in accordance with the present invention, and FIG. 2 is a block diagram showing each configuration of content packages and user preference in accordance with the present invention.

Referring to FIG. 1, a terminal 100 includes a customization client, e.g., a LFC client (Look&Feel Customization client) 110, and a DM client (Device Management client) 120.

The customization client (LFC client) 110 is an entity receiving a content package and preference according to a custom setting from a sever 200 and then executing all functions necessary to operate the content package.

Here, the preference, as shown in FIG. 2, includes profiles indicating categories pre-defined by the user and a condition indicating a detail set with respect to the profiles. The profile is a category pre-specified by the user, e.g., a traffic information profile, a stock profile, or a weather profile. The condition may be the detail set by the user according to temperature or rainfall in the weather profile, for example.

And, the content package is a collection of contents corresponding to a specific profile in the preference. The package includes a plurality of elements, that is a plurality of items as shown in FIG. 2, and a plurality of fields indicating information related to the package. The plurality of items are influenced by the condition of the package. That is, according to a pre-set condition, an Item 1 corresponding to a sound #1 and an Item 2 corresponding to a cloud image may be operated, or an Item 3 corresponding to a sound #2 and an Item 4 corresponding to a sun image may be operated, as shown in FIG. 2. Or, when it is snowing, a snowing image may be operated. A field indicating information related to the package includes a Pkg_ID field indicating an ID of a package, a User Profile_ID field indicating an ID of a profile corresponding to the package, etc. as shown in Table 3.

So as to manage the package, the customization client 110 includes a package manager 111.

The package manager 111 operates the package according to the profiles in the preference. And, the package manager 111 manages the package until a pre-set expire date, and then automatically destroys the package when it reaches the expire date. Also, the package manager 111 may additionally receive a content required according to a specific profile in the preference from the server 200 through the customization client 100. Also, the package manager 111 may execute a status management function. That is, the package manager 111 manages an installation status, a destroy status, an activation status, a deactivation status, and a resize status. The resize status is managed by checking whether or not the package is compressed according to a memory shortage of the terminal 100. Elements specifying detail functions of the package manager 111 are shown in Table 4.

Meanwhile, the DM client 120 manages information on the package and information on the signal as a Management Object (MO). Here, the DM client 120 may manage the MO in a tree format. The DM client 120 may connect with the server 200, particularly, the DM server 220 through a session and then receive several indications from the DM server 220. For example, the DM client 120 may receive indications such as transmission, installation, destroy, update, activation, deactivation of the package.

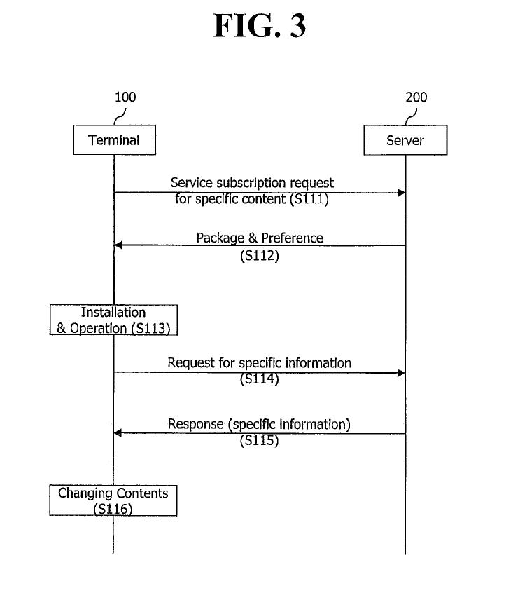

FIG. 3 is a flow chart showing a method for downloading and updating a content in accordance with the present invention.

Referring to FIG. 3, according to a method for downloading and updating a content in accordance with the present invention, when it is checked that a pre-set condition is satisfied according to newly received information while a content is operated, the terminal 100 replaces the content being operated with another content for operation. Hereafter, it will be explained in detail.

First, the terminal 100 transmits a subscription request message to the server 200 so as to receive a specific content (S101). Here, the subscription request message may be implemented as a service subscription request message.

The server 200 transmits a content package and preference pre-set by a user of the terminal 100, in response to the service subscription request message (S102).

The terminal 100 installs the received package and preference and then operates a specific content in the content package according to profiles in the received preference (S103).

Hereafter, in order to check whether or not a condition in the preference is satisfied, the terminal 100 transmits a request message for specific information to the server 200 (S104). The request message may be implemented as a request for specific information message, for example.

The server 200 transmits a response message to the terminal 100, in responds to the request for specific information message (S105). Here, the response message includes the specific information.

The terminal 100 checks whether or not a specific condition in the preference is satisfied according to the specific information in the response message, and then changes the content for operation when it is checked that the condition is satisfied (S106).

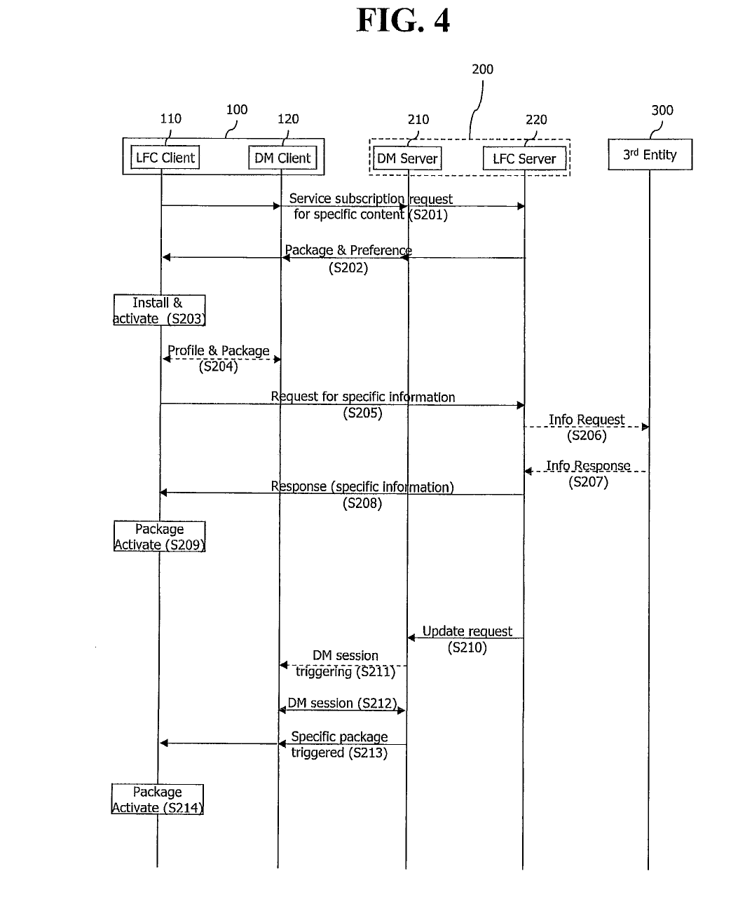

FIG. 4 is a flow chart specifically showing the method for downloading and updating a content in accordance with the present invention.

The flow chart shown in FIG. 4 illustrates the flow chart shown in FIG. 3 in more detail. It will be explained hereafter.

The LFC client 110 of the terminal 100 transmits a subscription request message to the LFC server 220 so as to receive a specific content (S201).

Here, the subscription request message may be transferred to the LFC server 220 through the DM client 120 and the DM server 210. And, the subscription request message may be implemented as a service subscription request message.

The LFC server 220 transmits a content package and preference pre-set by a user of the terminal 100 to the LFC client 110, in response to the service subscription request message (S202). Here, the package and preference may be transferred to the LFC client 110 through the DM server 210 and the DM client 120.

The LFC client 110 installs the received package and preference, and then operates a specific content in the content package according to profiles in the received preference (S203). And, the LFC client 100 allows the DM client 120 to map the installed package and preference to a management object in a DM tree.

Hereafter, the LFC client 110 transmits a request message for specific information to the LFC server 220 so as to check whether or not a condition in the preference is satisfied (S205). The request message may be implemented as request for specific information, for example.

Upon receiving the request message, the LFC server 220 checks whether or not the specific information is provided in itself. And then, when it is checked that the specific information is not provided in itself, the LFC server 220 transmits a request message, for example, Info Request message to a third entity 300 (S206). Upon receiving a response message, for example, Info Response message including the information from the third entity 300 (S207), the LFC server 230 transmits a response message to the LFC client 110 (S208). The response message includes the specific information.

The LFC client 110 checks whether or not a specific condition in the preference is satisfied according to the specific information in the response message, and then changes the content for operation when it is checked that the condition is satisfied (S209).

Through the processes above, it is capable of automatically downloading the content package and of automatically updating the same. In addition, the LFC server 220 can manage the content package installed in the terminal 100 through the DM server 220.

Particularly, when the LFC server 220 transmits an update request message to the DM server 210 so as to change the package being operated by the terminal 100 to another package (S210), the DM server 210 transmits a triggering message, for example, DM session triggering message so as to set a DM session with the DM client 120 of the terminal 100 (S211). When the DM session is set between the DM server 210 and the DM client 120 (S212), the DM server 210 transmits a package triggering message to the LFC client 110 through the DM client 120 (S213), and then the LFC client 110 changes the package being operated to another package for operation (S214).

TABLE 1

| Information | | |
|---|---|---|
| Element | Description | Data Type |
| UserPreference | It's the set of user preference to select the proper LFC | |
| | package comfortably. It is composed by the specified user | |
| | conditions and when DM Schedule is used, it operates | |
| | UserPreference using Timer-based or Trap-based | |
| | conditions. | |
| | Contains following attributes: | |
| | userPreference_id | |
| | version | |
| | description | |
| | conditionCriteria | |
| userPreference_id | UserPreference identifier. Unique name among the | String |
| | UserPreference lists. | |
| version | Version of the UserPreference. The newer version | unsignedInt |
| | overrides the older one. | |
| description | Describe how this profile will trigger and affect to the | String |
| | specific LFC package. | |
| Profile | Based on various conditions, UserPreference will be | |
| | composed and reflected to the specific LFC package usage. | |
| | Contains following elements: | |
| | profileID | |
| | Contains following attributes: | |
| | Profile ID A: ex; weather_profile | |
| | Profile ID B: ex; time_profile | |
| | Profile ID C: ex; subscriber_profile | |
| Conditions for | Condition: A (e.g time value(stamp) | |
| profileID | Condition: B (e.g Temperature 0 < T < 10) | |
| weather_profile | Weather information will be delivered from LFC server | String |
| | periodically. (For instance, they would be categorized like | |
| | ‘sun’, ‘rain’, ‘hot’, ‘snow’, ‘cold’, etc.) | |
| | User sets up the trap_based scheduling when the user | |
| | wants to operate and reflect the specific LFC package at the | |
| | specific weather conditions. As arriving the updated weather | |
| | data to the terminal, the defined trap_based condition will be | |
| | triggered by the client event and reflect the proper LFC | |
| | package. | |
| time_profile | User sets up the time_based scheduling when the user | String |
| | wants to operate and reflect the specific LFC package at the | |
| | specific time automatically. | |
| | The specific LFC package will be triggered and operated | |
| | at the defined time schedule by DM protocol. | |
| subscriber_profile | The stored LFC packages are distinguished by the | String |
| | subscriber and only possible to use by the right subscriber. | |
| | Based on the subscriber's LFC subscription and | |
| | possession, the LFC package will be triggered and operated | |
| | at the defined trap_based conditions. | |

Table 1 is an exemplary view showing a configuration of elements included in user preference.

Referring to Table 1, the user preference includes several elements. Particularly, the user preference includes a userPreference-id element indicating an ID, a version element indicating a version, a Profile element indicating an ID of a profile, and a Condition for profilelD element indicating detail conditions for the profile. Further, the user preference also includes, for example, a weather_profile based on weather, a time_profile based on time and a subscriber_profile based on whether or not a user subscribes, as profiles.

TABLE 2

| Information | | |
|---|---|---|
| Element | Description | Data Type |
| Element | The components of a LFC package. It's composed of | |
| | various contents as the same theme. | |
| | Contains following attributes: | |
| | element_id | |
| | contentType | |
| | contentProperty | |
| | postionDescription | |
| | groupingCriteria | |
| element_id | LFC element identifier. Unique name under a LFC | String |
| | package. | |
| contentType | The composed type of each element. | string |
| | Using contentType, element can indicate the targeted | |
| | applications or positions to be activated. The targeted | |
| | applications or positions can be already defined when the | |
| | contents are composed or they can be informed separately | |
| | when elements are delivered with description information. | |
| | For instance, ‘.gif’ file has to be located on the standby | |
| | screen. | |
| contentProperty | It describes the detail content property of each LFC | String |
| | element. It is the role to decide the LFC element can be | |
| | installed in the terminal or not. And the LFC elements can be | |
| | resized according to the terminal capability. | |
| Position | If the elements in LFC package are not defined the | String |
| Description | specific position for installation/activation, it provides the | |
| | description of the targeted applications and positions. | |
| groupingCriteria | The high level criteria to group LFC elements | String |
| | according to the conditions. Using grouping criteria, the related | |
| | elements would be processed and managed at the same time. | |
| | A LFC element is only included at the one group at the same | |
| | time. | |
| | Contains following attributes: | |
| | tag | |
| | elementExpiration | |
| | premium_label | |
| tag | The added representative words to distinguish the | String |
| | each LFC element. Using tag, the LFC element would be | |
| | grouped as the disposition. | |
| | For instance, they will be separated, [sound], [screen], | |
| | [indicator], [font], etc.. | |
| Element | Based on expire period, LFC element would be | dateTime |
| Expiration | grouped. For instance, the premium contents would be applied | |
| | shortly than others or preview contents having limited period | |
| | also can be applied. The formats follow as specified in ISO | |
| | 8601. | |
| | yyyy = year | |
| | mm = month | |
| | dd = day | |
| premium_label | As composing the LFC elements as a LFC package, | String |
| | each LFC elements can be differentiated as access conditions, | |
| | usage controls, lock/unlock, etc which are saying as a premium | |
| | service. The related LFC comments would be managed at the | |
| | same time. | |

Table. 2 is an exemplary view showing elements included in a package.

Referring to Table. 2, elements included in the package, namely, items have various properties. Particularly, each element, that is the item includes an element_id field indicating an ID of itself, a contentType field indicating a type of the item, a contentProperty field indicating a property of the item, a positionDescription field indicating an operating application, a groupingCriteria field indicating a grouping of the items, a tag field for distinguishing each item, an elementExpiration field indicating an expiration time of the item, etc.

TABLE 3

| Information | | |
|---|---|---|
| Element | Description | Data Type |
| Package | A set of UI contents under the same theme. Several Packages | |
| | would be listed up in the LFC Client, but the only one SHALL be | |
| | selected and applied. | |
| | Contains following attributes: pkg_id, priority, dw_date, version, | |
| | pkgExpiration, genre, userProfile_id | |
| pkg_id | LFC package identifier. Unique name will be defined at the each | String |
| | provider. | |
| priority | Among the LFC packages, the precedence will be decided by | string |
| | user selection or the order of installation of LFC package. | |
| | If the current priority 1 was deleted or expired, the next prior one | |
| | will be set automatically as priority 1. If there are no more LFC | |
| | package, the default contents will be set automatically as priority | |
| | 1. Note: Basically, the first LFC package will be set as the highest, | |
| | priority 1. | |
| dw_date | The moment when the LFC package was downloaded in the | dateTime |
| | device. The formats follow as specified in ISO 8601. | |
| | YYYY = four-digit year | |
| | MM = two-digit month (01 = January, etc.) | |
| | DD = two-digit day of month (01 through 31) | |
| | hh = two digits of hour (00 through 23) (am/pm NOT allowed) | |
| | mm = two digits of minute (00 through 59) | |
| | ss = two digits of second (00 through 59) | |
| | Note: It'll be the basis of content expiration. | |
| version | Version of the LFC package. The newer version overrides the | unsignedInt |
| | older one. | |
| pkgExpiration | The date of LFC package expiration. It'll be calculated using | unsignedInt |
| | ‘dw_date’ attribute. | |
| | Expired contents will be deleted or put the users note to remind | |
| | the expiration which can give the update chances. | |
| genre | It'll be basis to distinguish the LFC package as theme. Also, it can | String |
| | be used to parental check before delivery the LFC package. | |
| userProfile_id | It's the user preference composite to select and reflect the LFC | String |
| | package properly. | |
| | Selected UserProfile will be applied to select and deliver the | |
| | proper LFC package and avoid the confliction of different | |
| | UserProfile at the same time. | |
| suggested_model | It'll be provided for the pre-checking to apply the specific LFC | string |
| | package well to the related model before delivery the package. | |
| | The model type will be globally distinguished at the each provider. | |
| refpreview_id | It's the reference of ‘preview_id’ attribute related to the specific | String |
| | LFC package. Before subscription and delivery the specific | |
| | contents, the preview services give the chance for short | |
| | introduction and to modify the LFC package properly for the | |
| | terminal. | |

Table. 3 is an exemplary view showing related information fields included in a package.

Referring to Table. 3, the package includes fields indicating related information. That is, the package includes a Pkg_ID field indicating an ID of the package, a Priority field indicating a priority, a dw_date field indicating a downloaded time, a version field, a pkgExpiration field indicating an expiration time of the package, a genre field indicating a genre of the package, a User Profile_ID field indicating an ID of a profile corresponding to the package, a suggested_model field indicating a product to which the package can be applied, and a refpreview_id field indicating information on a related function by which the package can be previewed.

TABLE 4

| Information | | |
|---|---|---|
| Element | Description | Data Type |
| PkgManager | The delivered LFC packages are managed by PkgManager | |
| | overall. Based on the constraints of the specific LFC package, they | |
| | are operated and only a LFC package gets to be activated at a | |
| | time. | |
| | Contains the following attributes: pkg_id, timer, | |
| | download_date, pkg_expiration, element_expiration, | |
| | status_manager | |
| pkg_id | The ID of downloaded LFC packages. It's used to manage the | String |
| | specific package. | |
| timer | It's always be referenced with the terminal GMT time. Based | dateTime |
| | on this value, whole downloaded LFC package are managed. | |
| | It starts to count from either downloading the LFC Package | |
| | from LFC server or activating the downloaded LFC Package in the | |
| | LFC Client. | |
| pkg_expiration | The date of LFC package expiration. It can be calculated with | String |
| | ‘download_date’ attribute. (for instance, this LFC package will be | |
| | valid for 7 days and the expiration will be calculated using the | |
| | ‘download_date’) or it can be mentioned the specific expiration date | |
| | as specified in ISO 8601. | |
| | Expired LFC package will be deleted or put note to remind the | |
| | expiration which can give the update chances. | |
| element_expiration | Based on expiration date of LFC elements, each LFC element | |
| | can be grouped having same expiration date. For instance, the | |
| | premium contents would be applied shortly than others, so the | |
| | premium contents will be grouped as one and preview contents | |
| | having limited period also can be managed as a group. | |
| | The expiration date can be calculated with ‘downloadDate’ | |
| | attribute. (for instance, this LFC package will be valid for 7 days | |
| | and the expiration will be calculated using the ‘download_date’) or | |
| | it can be mentioned the specific expiration date as specified in ISO | |
| | 8601. | |
| status_manager | Either a user input or the defined conditions, the LFC | |
| | packages and elements are managed automatically using one of | |
| | below defined functions. | |
| | In case of ‘Remote Management’ model, the | |
| | Contains following attributes: installation, destroy, activation, | |
| | deactivation | |
| installation | Downloaded LFC package can be installed right after storing | string |
| | in the terminal, but they also can be installed at the defined time | |
| | automatically or as getting user input later. | |
| | Contains following attributes: | |
| | resizing | |
| resizing | Before the LFC package is installed and reflects each LFC | string |
| | element in the terminal, the size of LFC element can be updated | |
| | according to the terminal capability. | |
| | Before installation, either the ‘contentProperty’ in LFC | |
| | Element fragment or ‘package_update’ in LFC Preview fragment | |
| | will be applied according to the conditions and then they are | |
| | resized according to them. | |
| destroy | Following to the defined expiration date; the specific LFC | string |
| | package is destroyed. The PkgManager will check the expiration | |
| | date periodically and the expired LFC package is destroyed or | |
| | unusable. | |
| activation | The one selected LFC package is activated. It is chose by the | string |
| | Priority = 1 LFC package automatically or user selection/input. | |
| | Activation means the LFC package is installed and presented | |
| | in the defined location of screen. | |
| deactivation | It's not meant to be destroyed of LFC package. As a specific | string |
| | package is deactivated, the next prior package is activated | |
| | automatically. If there are not more listed packages, the default | |
| | setting values are presented. | |

Table. 4 is an exemplary view showing elements for a package manager.

The elements for the package manager 111 include a pkg_id element indicating an ID of a package, a timer element indicating time information, a pkg_expiration element indicating an expiration time of the package, an element_expiration element indicating an expiration time of elements in the package, a status_manager element indicating a status of the package, an installation element indicating whether or not the package is installed, a destroy element indicating whether or not the package is destroyed, an activation element indicating whether or not the package is operated (activated), a deactivation element indicating whether or not operation of the package is stopped (whether or not the package is deactivated), and a resizing element indicating whether or not the package is compressed.

According to the present invention, it is capable of automatically downloading a content as user preference and of automatically updating the content, accordingly convenience for the user can be enhanced. And, a buying desire of the user on the content increases, accordingly a service provider can stably make profits.

It will also be apparent to those skilled in the art that various modifications and variations can be made in the present invention without departing from the spirit or scope of the invention. Thus, it is intended that the present invention cover modifications and variations of this invention provided they come within the scope of the appended claims and their equivalents.

1. A method for receiving a customized content in a terminal, the method comprising:
transmitting a service subscription request message to a server;
receiving user preference and one or more content packages from the server, wherein the user preference comprises elements indicating one or more profiles pre-defined by a user and a pre-defined condition, and each of the content packages comprises an element indicating an identifier of a profile related to itself; and
operating a specific content package according to a corresponding profile when the pre-defined condition in the user preference is satisfied.

2. The method of claim 1, wherein the content package further comprises one or more of a pkg_id element indicating an ID and a priority element indicating an operation priority.

3. The method of claim 1, wherein the user preference further comprises:
a userPreference_id element indicating an ID; and
a Profile element indicating Ids of one or more profiles.

4. The method of claim 1, further comprises managing a status of the package.

5. The method of claim 4, wherein the status of the package corresponds to one of an installation status, a destroy status, an activation status and a deactivation status.

6. The method of claim 1, wherein the operating step comprises:
transmitting a request message for specific information so as to check whether or not the condition is satisfied;
receiving a response message including the specific information from the server; and
operating the specific content package according to the specific profile corresponding to the condition when it is checked that the condition is satisfied based on the specific information.

7. A terminal comprising:
a first client receiving from a server one or more content packages and user preference including elements indicating one or more profiles pre-defined by a user and a pre-defined condition and then operating a specific content package according to a corresponding profile when the pre-defined condition in the received user preference is satisfied, wherein the first client comprises a package manager managing the packages; and
a second client managing the received user preference and the content package in a device management tree format.

8. The terminal of claim 7, wherein the content package further comprises one or more of a pkg_id element indicating an ID and a priority element indicating an operation priority.

9. The terminal of claim 7, wherein the user reference further comprises:
a userPreference_id element indicating an ID; and
a Profile element indicating IDs of one or more profiles.

10. The terminal of claim 7, wherein the package manager manages which status the package is in among an installation status, a destroy status, an activation status and a deactivation status.
